(19) United States
(12) Patent Application Publication
(10) Pub. No.: US 2021/0154734 A1
(43) Pub. Date: May 27, 2021

(54) CASTING DEVICE AND CASTING METHOD

(71) Applicant: SINTOKOGIO, LTD., Nagoya-shi, Aichi (JP)

(72) Inventors: Keishiro KANEDA, Toyokawa-shi, Aichi (JP); Yukiyoshi FUNAKOSHI, Toyokawa-shi, Aichi (JP)

(73) Assignee: SINTOKOGIO, LTD., Nagoya-shi, Aichi (JP)

(21) Appl. No.: 16/649,843

(22) PCT Filed: Sep. 25, 2018
(86) PCT No.: PCT/JP2018/035344

§ 371 Date: Mar. 23, 2020

(30) Foreign Application Priority Data
Sep. 27, 2017 (JP) 2017-186331

(51) Int. Cl. B22D 33/04; B22D 23/02

(52) U.S. Cl. CPC B22D 33/04; B22D 23/02

(57) ABSTRACT

A casting apparatus includes an upper frame to which an upper mold is attached, a lower frame to which a lower mold is attached, a first hydraulic actuator, a hydraulic unit, a first main link member, a first sub-link member and a rotation actuator, and the upper frame, the lower frame, the first main link member and the first sub-link member constitute a first parallel link mechanism. The hydraulic unit causes the electric motor to operate at a predetermined number of revolutions when performing mold opening or mold closing and causes the electric motor to operate at a limit number of revolutions smaller than the predetermined number of revolutions when not performing mold opening or mold closing.

### TECHNICAL FIELD

The present disclosure relates to a casting apparatus and a casting method.

### BACKGROUND ART

Patent Document 1 discloses a gravity type tilting die casting apparatus. This apparatus is provided with an upper frame, a lower frame, an opening/closing mechanism, a first main link member, a first sub-link member and a drive unit. An upper mold is attached to the upper frame. A lower mold is attached to the lower frame. The opening/closing mechanism opens or closes the upper mold and the lower mold by moving either the upper mold or the lower mold up and down. A top end part of the first main link member is rotatably connected to the upper frame, a bottom end part of the first main link member is rotatably connected to the lower frame, and the first main link member is provided with a rotating shaft at a central part thereof. The first sub-link member is disposed parallel to the first main link member, a top end part of the first sub-link member is rotatably connected to the upper frame, and a bottom end part of the first sub-link member is rotatably connected to the lower frame and is provided with a rotating shaft at a central part thereof. The drive unit is connected to the rotating shaft of the first main link member and rotates the first main link member around the rotating shaft. The upper frame, the lower frame, the first main link member and the first sub-link member constitute a first parallel link mechanism.

### CITATION LIST

### Patent Document

Patent Document 1: Japanese Patent Publication No. 5880792

### SUMMARY OF INVENTION

### Technical Problem

There is still room for improvement in the casting apparatus described in Patent Document 1 in terms of casting while suppressing power consumption.

### Solution to Problem

An aspect of the present disclosure is a casting apparatus that forms a casting by using an upper mold and a lower mold, which can be opened, closed, and tilted, into which molten metal is poured by using gravity. The casting apparatus includes a first hydraulic actuator and a hydraulic unit. The first hydraulic actuator moves either the upper mold or the lower mold up and down to thereby open or close the upper mold and the lower mold. The hydraulic unit drives the first hydraulic actuator. The hydraulic unit includes a hydraulic pump supplying hydraulic oil to the first hydraulic actuator, an electric motor driving the hydraulic pump and a drive control unit controlling a number of revolutions of the electric motor. The drive control unit operates an electric motor at a predetermined number of revolutions when performing mold opening or mold closing, and when not performing mold opening or mold closing, the drive control unit operates the electric motor at a limit number of revolutions smaller than the predetermined number of revolutions.

In this casting apparatus, the first hydraulic actuator realizes mold closing and mold opening. The drive control unit causes the electric motor of the hydraulic pump supplying hydraulic oil to the first hydraulic actuator to operate at the predetermined number of revolutions when performing mold opening or mold closing and operate at a limit number of revolutions smaller than the predetermined number of revolutions when not performing mold opening or mold closing. The casting apparatus can thereby suppress power consumption compared to a case where the electric motor is always caused to operate at the number of revolutions necessary for mold opening or mold closing.

In an embodiment, the first hydraulic actuator may move the upper mold up and down to perform mold closing and mold opening. The casting apparatus may further include a lower pushing out pin inserted into a hole communicating with a lower cavity of the lower mold in which a casting is formed, a leading end of which pushes out the casting in the lower cavity, and a second hydraulic actuator connected to the hydraulic unit to move the lower pushing out pin up and down. The hydraulic pump may further supply hydraulic oil to the second hydraulic actuator when performing mold opening.

In the casting apparatus, the first hydraulic actuator for mold closing and mold opening is provided in the upper frame. The second hydraulic actuator is provided to push out the casting from the lower mold when performing mold opening. The second hydraulic actuator is connected to the hydraulic unit to which the first hydraulic actuator is connected. In this way, the plurality of hydraulic actuators are operated by one hydraulic unit, and it is thereby possible to suppress power consumption compared to the case where the hydraulic actuators are connected to their respective hydraulic units each including an electric motor.

In an embodiment, the casting apparatus may further include an upper pushing out plate enabled by the first hydraulic actuator to freely move up and down and an upper pushing out pin inserted into a hole communicating with an upper cavity of the upper mold in which a casting is formed, caused by the first hydraulic actuator to move up and down, and a leading end of which pushes out the casting in the upper cavity. When removing the casting in the upper cavity from the mold, the drive control unit may cause the electric motor to operate at a number of revolutions larger than the limit number of revolutions.

In the casting apparatus, when the casting is removed from the upper mold, the electric motor is operated at a number of revolutions larger than the limit number of revolutions to operate the first hydraulic actuator. That is, in the casting apparatus, since the electric motor can be operated at the limit number of revolutions except for mold closing, mold opening or mold removal, it is possible to suppress power consumption compared to the case where the electric motor is always operated at a number of revolutions necessary for mold opening or mold closing.

In an embodiment, the first hydraulic actuator may move the lower mold up and down to thereby perform mold closing and mold opening. The casting apparatus may further include an upper pushing out pin inserted into a hole communicating with an upper cavity of the upper mold in which a casting is formed, a leading end of which pushes out the casting in the upper cavity and a second hydraulic actuator connected to the hydraulic unit and moving the upper pushing out pin up and down. The hydraulic pump may further supply hydraulic oil to the second hydraulic actuator when performing mold opening.

In the casting apparatus, the first hydraulic actuator for mold closing and mold opening is provided in the lower frame. The second hydraulic actuator is provided to push out a casting from the upper mold at the time of mold opening. The second hydraulic actuator is connected to the hydraulic unit to which the first hydraulic actuator is connected. In this way, the plurality of hydraulic actuators are operated by one hydraulic unit, and it is thereby possible to suppress power consumption compared to the case where the hydraulic actuators are connected to their respective hydraulic units each including an electric motor.

In an embodiment, the casting apparatus may further include a lower pushing out plate enabled by the first hydraulic actuator to freely move up and down and an upper pushing out pin inserted into a hole communicating with a lower cavity of the lower mold in which a casting is formed, caused by the first hydraulic actuator to move up and down, and a leading end of which pushes out the casting in the lower cavity. When removing the casting in the lower cavity from the mold, the drive control unit may cause the electric motor to operate at a number of revolutions larger than the limit number of revolutions.

In the casting apparatus, when removing the casting from the lower mold, the electric motor is operated at a number of revolutions larger than the limit number of revolutions to operate the first hydraulic actuator. That is, in the casting apparatus, the electric motor can be operated at the limit number of revolutions except for mold closing, mold opening or mold removal. It is thereby possible for the casting apparatus to suppress power consumption compared to a case where the electric motor is always operated at a number of revolutions necessary for mold opening or mold closing.

In an embodiment, the drive control unit may reduce the number of revolutions of the electric motor when performing mold closing compared to when performing mold opening. In the case of mold opening, since a casting needs to be removed from the mold, a larger number of revolutions is necessary than in the case of mold closing. The apparatus can suppress power consumption compared to the case where the electric motor is always operated at a number of revolutions necessary for mold opening.

In an embodiment, the casting apparatus may also include an upper frame to which the upper mold is attached, a lower frame to which the lower mold is attached, a first main link member, a top end part of which is rotatably connected to the upper frame, a bottom end part of which is rotatably connected to the lower frame and a central part of which is provided with a rotating shaft, a first sub-link member disposed parallel to the first main link member, a top end part of which is rotatably connected to the upper frame, a bottom end part of which is rotatably connected to the lower frame and a central part of which is provided with a rotating shaft and a drive unit connected to the rotating shaft of the first main link member and rotating the first main link member around the rotating shaft as a center, and the upper frame, the lower frame, the first main link member and the first sub-link member may constitute a first parallel link mechanism. The casting apparatus comprising the link mechanism configured as described above can suppress power consumption.

In an embodiment, the drive unit may be a servo motor. In such a configuration, the drive unit can cause the link mechanism more accurately operated compared to the case where the drive unit is a hydraulic actuator.

In an embodiment, when the upper mold and the lower mold are tilted or when the upper mold is separated from the lower mold in the horizontal direction, the servo motor may be supplied with power. When not in operation, the servo motor consumes no power. The apparatus can suppress power consumption compared to the case where the drive unit is a hydraulic actuator.

Another aspect of the present disclosure is a casting method using a casting apparatus that forms a casting by using an upper mold and a lower mold, which can be opened, closed, and tilted, into which molten metal is poured by using gravity. The casting apparatus includes a first hydraulic actuator and a hydraulic unit. The first hydraulic actuator moves either the upper mold or the lower mold up and down to thereby open or close the upper mold and the lower mold. The hydraulic unit drives the first hydraulic actuator. The hydraulic unit includes a hydraulic pump supplying hydraulic oil to the first hydraulic actuator and an electric motor driving the hydraulic pump. The method includes a mold closing step and a mold opening step. In the mold closing step and the mold opening step, the electric motor operates at a predetermined number of revolutions, and when not in the mold closing step or in the mold opening step, the electric motor operates at a limit number of revolutions smaller than the predetermined number of revolutions.

The present casting method exerts the same effects as those of the aforementioned casting apparatus.

### Advantageous Effects of Invention

According to the present disclosure, it is possible to suppress power consumption of the casting apparatus.

### BRIEF DESCRIPTION OF DRAWINGS

FIG. 1 is a front view of a casting apparatus according to a first embodiment.

FIG. 2 is a side view of the casting apparatus in FIG. 1.

FIG. 3 is a diagram illustrating a cross section of an upper mold and a lower mold in FIG. 1.

FIG. 4 is a block diagram of a configuration relating to driving of the casting apparatus in FIG. 1.

FIG. 5 is a flowchart illustrating a casting method by the casting apparatus in FIG. 1.

FIG. 6 is a graph illustrating power supplied to a servo motor in each step and a number of revolutions of an electric motor of a hydraulic pump.

FIG. 7 is a diagram viewed from an arrow direction of a line A-A in FIG. 1 and for describing an apparatus starting state.

FIG. 8 is a diagram illustrating a second separate state in which upper and lower molds are slid through operation of a parallel link mechanism and describing an initial state of a manufacturing step.

FIG. 9 is a diagram for describing a mold closed state in which the upper mold and the lower mold are closed.

FIG. 10 is a diagram in which the closed upper mold and lower mold are tilted by 90°.

FIG. 11 is a diagram illustrating the upper mold raised up to a midway position.

FIG. 12 is a diagram illustrating the upper mold and the lower mold slid into a first separate state.

FIG. 13 is a diagram illustrating the upper mold raised from the state in FIG. 12 up to an ascending end.

FIG. 14 is a front view of a casting apparatus according to a second embodiment.

FIG. 15 is a diagram illustrating a cross section of an upper mold and a lower mold in FIG. 14.

### DESCRIPTION OF EMBODIMENTS

Hereinafter, embodiments of the present invention will be described with reference to the accompanying drawings. Note that the same elements in description of the drawings are assigned the same reference numerals and duplicate description thereof will be omitted. Moreover, dimensional ratios among the drawings do not always correspond to those in the description. Terms like “up,” “down,” “left” and “right” are based on the illustrated states and used for convenience’ sake.

### First Embodiment

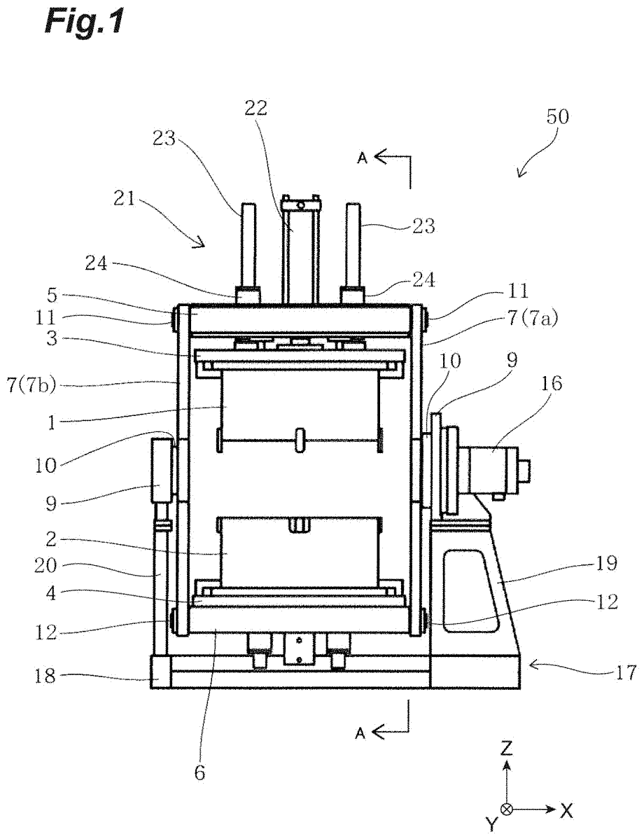

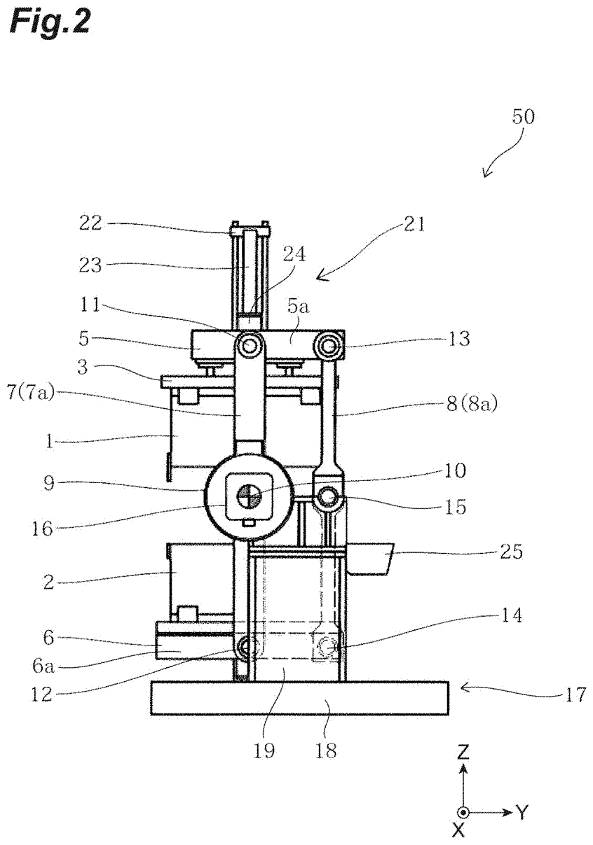

A configuration of a casting apparatus 50 will be described with reference to FIG. 1 and FIG. 2. FIG. 1 is a front view of a casting apparatus according to a first embodiment. FIG. 2 is a side view of the casting apparatus in FIG. 1. An X direction and a Y direction in the drawings are horizontal directions and a Z direction is a vertical direction. Hereinafter, the X direction will also be referred to as a left-right direction and the Z direction will also be referred to as an up-down direction.

The casting apparatus 50 is a so-called gravity type tilting die casting apparatus into which molten metal is poured using gravity and which forms a casting using an upper mold 1 and a lower mold 2 which can be opened, closed and tilted. The molten metal to be poured can be any material. Examples of the molten metal to be used include aluminum alloy and magnesium alloy. The casting apparatus 50 includes a controller and is configured to be able to control operations of respective components.

As shown in FIG. 1 and FIG. 2, the casting apparatus 50 is provided with, for example, a base frame 17, an upper frame 5, a lower frame 6, an opening/closing mechanism 21, a pair of left and right main link members 7 (first main link member 7a, second main link member 7b), a pair of left and right sub-link members 8 (first sub-link member 8a, second sub-link member 8b), a rotation actuator 16 (drive unit) and a ladle 25.

The base frame 17 includes a base 18, a drive side support frame 19 and a driven side support frame 20. The base 18 is a substantially flat plate member composed by combining a plurality of members and is provided horizontally on an installation surface of the casting apparatus 50. The drive side support frame 19 and the driven side support frame 20 are erected on the base 18 in such a way as to face each other in the left-right direction (horizontal direction) and are fixed to the base 18. A pair of tilting rotation bearings 9 is provided at a top end part of the drive side support frame 19 and a top end part of the driven side support frame 20.

The upper frame 5 is disposed above the base frame 17. The upper mold 1 is attached to the upper frame 5. More specifically, the upper mold 1 is mounted on an undersurface of the upper frame 5 via an upper mold die base 3. The upper frame 5 is provided with the opening/closing mechanism 21 moving the upper mold 1 up and down. More specifically, the upper frame 5 incorporates the opening/closing mechanism 21 and holds the upper mold 1 in such a way as to be movable up and down through the opening/closing mechanism 21.

The opening/closing mechanism 21 includes a first hydraulic actuator 22, a pair of left and right guide rods 23 and a pair of left and right guide cylinders 24. The first hydraulic actuator 22 moves either the upper mold 1 or the lower mold 2 up and down to thereby open or close the upper mold 1 and the lower mold 2. In the present embodiment, the first hydraulic actuator 22 moves the upper mold 1 up. A bottom end part of the first hydraulic actuator 22 is mounted on a top surface of the upper mold die base 3. The first hydraulic actuator 22 extends in an up-down direction (vertical direction; Z direction here) to thereby move the upper mold 1 down via the upper mold die base 3, and is contracted in the up-down direction to thereby move the upper mold 1 up via the upper mold die base 3. An example of the first hydraulic actuator 22 is a hydraulic cylinder. The guide rods 23 are mounted on the top surface of the upper mold die base 3 through the guide cylinder 24 mounted on the upper frame 5.

The lower frame 6 is disposed above the base frame 17 and below the upper frame 5. The lower mold 2 is attached to the lower frame 6. More specifically, the lower mold 2 is mounted on a top surface of the lower frame 6 via a lower mold die base 4. In the state shown in FIG. 1 and FIG. 2, the upper frame 5 and the lower frame 6 face each other in the up-down direction. Similarly, the upper mold 1 and the lower mold 2 face each other in the up-down direction. The opening/closing mechanism 21 moves the upper mold 1 up and down to thereby close or open the upper mold 1 and the lower mold 2.

The first main link member 7a is a long member. The first main link member 7a is, for example, a bar-like member having a rectangular cross section. A top end part of the first main link member 7a is rotatably connected to the upper frame 5, a bottom end part thereof is rotatably connected to the lower frame 6 and the first main link member 7a is provided with a tilt rotating shaft 10 at a central part thereof. The first main link member 7a includes a main link upper rotating shaft 11 at the top end part thereof and a main link lower rotating shaft 12 at a bottom end part thereof. In the present embodiment, the first main link member 7a is provided with two main link members. The second main link member 7b has the same configuration as that of the first main link member 7a. The pair of main link members 7 is arranged in such a way as to face each other in the left-right direction (horizontal direction; X direction here) and connect the upper frame 5 and the lower frame 6 respectively. Here, the pair of main link members 7 is arranged in parallel in such a way as to face each other across the upper mold 1 and the lower mold 2.

The central parts of the pair of main link members 7 are rotatably connected to the pair of tilting rotation bearings 9 via the pair of tilt rotating shafts 10. The top end parts of the pair of main link members 7 are rotatably connected to a pair of side faces 5a of the upper frame 5 via the pair of main link upper rotating shafts 11. The bottom end parts of the pair of main link members 7 are rotatably connected to a pair of side faces 6a of the lower frame 6 via the pair of main link lower rotating shafts 12. When the upper mold 1 and the lower mold 2 are closed, the mounting positions of the pair of main link members 7 with respect to the upper frame 5 and the lower frame 6 are set so that the pair of main link members 7 is located at the respective centers of the upper mold 1 and the lower mold 2 in a depth direction (Y direction) orthogonal to the left-right direction and the up-down direction.

The first sub-link member 8a is a long member. The first sub-link member 8a is, for example, a bar-like member having a rectangular cross section. The first sub-link member 8a is arranged parallel to the first main link member 7a, top end parts of which are rotatably connected to the upper frame 5, bottom end parts of which are rotatably connected to the lower frame 6, and is provided with a sub-link central part rotating shaft 15 at a central part thereof. The first sub-link member 8a includes a sub-link upper rotating shaft 13 at a top end part thereof and a sub-link lower rotating shaft 14 at a bottom end part thereof. Two sub-link members are provided in the present embodiment. The second sub-link member 8b (not shown) has the same configuration as that of the first sub-link member 8a. The pair of sub-link members 8 is arranged in such a way as to face each other in the left-right direction, and connect the upper frame 5 and the lower frame 6. The pair of sub-link members 8 is disposed on the pair of side faces 5a and the pair of side faces 6a in such a way as to be parallel to the pair of main link members 7. The sub-link member 8 has the same length as that of the main link member 7.

The top end parts of the pair of sub-link members 8 are rotatably connected to the pair of side faces 5a of the upper frame 5 via the pair of sub-link upper rotating shafts 13. The bottom end parts of the sub-link members 8 are rotatably connected to the pair of side faces 6a of the lower frame 6 via a pair of sub-link lower rotating shafts 14. The mounting position of the sub-link member 8 is on a side where the ladle 25 is disposed with respect to the main link member 7. The sub-link central part rotating shaft 15 is placed above the base frame 17. In the state in FIG. 1 and FIG. 2, the sub-link central part rotating shaft 15 is placed on a top surface of the drive side support frame 19.

In this way, the upper frame 5, the lower frame 6, the first main link member 7a and the first sub-link member 8a constitute a parallel link mechanism (first parallel link mechanism). Similarly, the upper frame 5, the lower frame 6, the second main link member 7b and the second sub-link member 8b constitute a parallel link mechanism (second parallel link mechanism). The two parallel link mechanisms are arranged in parallel in such a way as to face each other across the upper mold 1 and the lower mold 2.

The tilt rotating shaft 10 of the first main link member 7a is held to the base frame 17 by a tilting rotation bearing 9 provided outside the first parallel link mechanism. The center of rotation of the tilt rotating shaft 10 of the first main link member 7a coincides with the center of gravity of a rotation body including the closed or opened upper mold 1 and lower mold 2, and the upper frame 5 and the lower frame 6. Similarly, the tilt rotating shaft 10 of the second main link member 7b is held to the base frame 17 by the tilting rotation bearing 9 provided outside the second parallel link mechanism. The center of rotation of the tilt rotating shaft 10 of the second main link member 7b coincides with the center of gravity of the rotation body including the closed or opened upper mold 1 and lower mold 2, and the upper frame 5 and the lower frame 6. Here, “coincide” is not limited to a case where both coincide completely, but includes a case where errors are contained due to a difference between the weight of the upper mold 1 and the weight of the lower mold 2.

The rotation actuator 16 is disposed above the drive side support frame 19. The rotation actuator 16 is provided in connection with one tilt rotating shaft 10 of the pair of main link members 7. The rotation actuator 16 may be operated by any one of electric motor, hydraulic pressure and pneumatic pressure. An example of the rotation actuator 16 is a servo motor. The servo motor is connected to a power supply and operates when supplied with power. The rotation actuator 16 functions as a drive unit separating the upper mold 1 from the lower mold 2 in the tilting or horizontal direction.

The upper mold 1 and the lower mold 2 are tilted when the rotation actuator 16 rotates the tilt rotating shaft 10 of the first main link member 7a by 45° to 130° with the upper mold 1 and the lower mold 2 closed by the opening/closing mechanism 21. The upper mold 1 is separated from the lower mold 2 in the horizontal direction when the rotation actuator 16 causes the tilt rotating shaft 10 of the first main link member 7a to rotate by a predetermined angle with the upper mold 1 and the lower mold 2 closed by the opening/closing mechanism 21. Separation of the upper mold 1 from the lower mold 2 in the horizontal direction is realized by the rotation actuator 16 causing the first parallel link mechanism to act. At this time, the second parallel link mechanism also acts in accordance with the movement of the first parallel link mechanism. Note that the second parallel link mechanism is not essential, but the upper frame 5 and the lower frame 6 may be connected by, for example, only the first parallel link mechanism and the second main link member 7b, or the upper frame 5 and the lower frame 6 may be connected by only the first parallel link mechanism and the second sub-link member 8b.

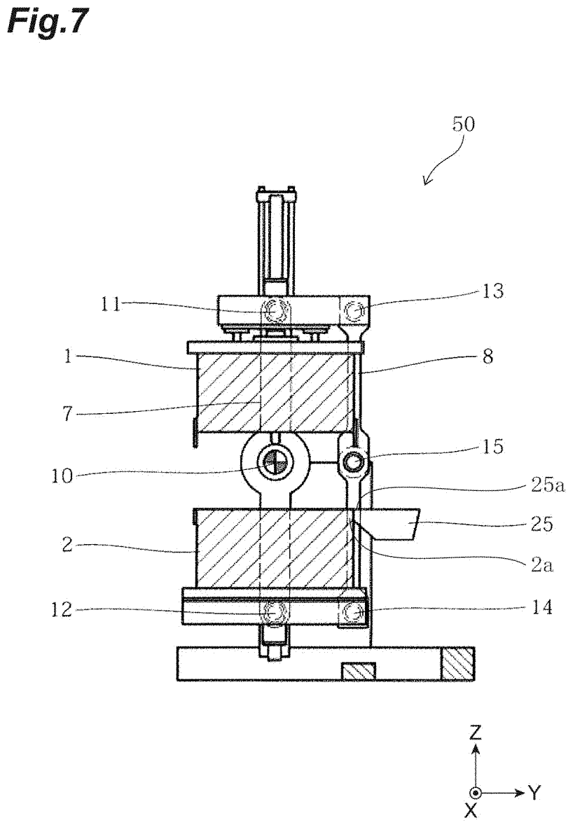

The ladle 25 is mounted at a top end part of the side face of the lower mold 2. A storage part for storing molten metal is defined in the ladle 25. A pouring port 25a (see FIG. 7) of the ladle 25 is connected to a receiving port 2a of the lower mold 2 (see FIG. 7).

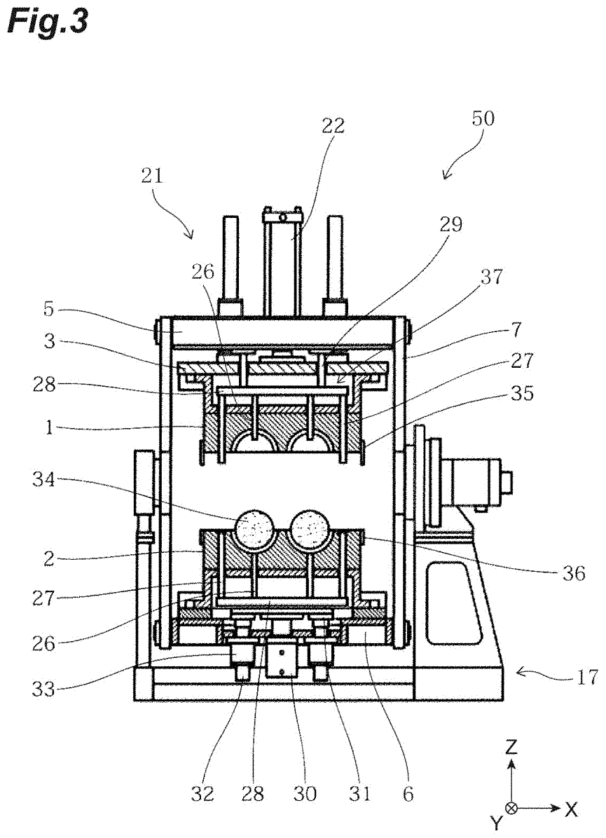

FIG. 3 is a diagram illustrating cross sections of the upper mold and the lower mold in FIG. 1. Here, a state is shown in which a plurality of cores 34 are fitted on a top surface of the lower mold 2. As shown in FIG. 3, the casting apparatus 50 is provided with a pushing out mechanism 37 including a pushing out plate 28 (upper pushing out plate), a pair of pushing out pins 26 (upper pushing out pin), a pair of return pins 27 and a plurality of push rods (regulating member) 29. The pushing out mechanism 37 is provided in the upper frame 5.

The pushing out plate 28 is disposed in an inner space formed in the interior on a top end side of the upper mold 1. The pushing out plate 28 is fitted in the inner space in such a way as to be freely movable up and down. Each pushing out pin 26 is provided on an undersurface of the pushing out plate 28. Each pushing out pin 26 moves up and down through a hole from the inner surface of the upper mold 1 to a cavity (upper cavity) in which a casting is formed. Each pushing out pin 26 pushes out the casting in the cavity by a distal end thereof. Each return pin 27 is provided at a position of the pushing out plate 28 different from the pushing out pin 26 of the undersurface. Each return pin 27 moves up and down through the hole from the inner space of the upper mold 1 to an undersurface of the upper mold 1. Each return pin 27 causes the pushing out plate 28 to move up when the distal end of the return pin 27 abuts against the top surface of the lower mold 2 in a process in which the upper mold 1 and the lower mold 2 are closed.

Each push rod 29 is provided on the undersurface of the upper frame 5. Each push rod 29 is disposed on the undersurface of the upper frame 5 by penetrating the upper mold die base 3. The distal end of each push rod 29 is disposed above the pushing out plate 28 into the inner space with each push rod 29 inserted into the hole from the top surface of the upper mold 1 to the inner space. The length of each push rod 29 is set to a length at which the pushing out plate 28 is pushed down when the first hydraulic actuator 22 is contracted and the upper mold 1 reaches an ascending end. Note that the ascending end is a highest possible position of the upper mold 1 as the first hydraulic actuator 22 is contracted. That is, each push rod 29 passes through the hole from the top surface of the upper mold 1 into the inner space formed at a position above the upper mold 1 entering the inner space by a predetermined length to thereby prevent the pushing out plate 28 from moving up.

The lower frame 6 incorporates a second hydraulic actuator 30. An example of the second hydraulic actuator 30 is a hydraulic cylinder. A top end part of the second hydraulic actuator 30 is mounted on an undersurface of the pushing out member 31. A pair of left and right guide rods 32 passes through guide cylinders 33 attached to the lower frame 6 and is mounted on the undersurface of the pushing out member 31.

Just like the upper mold 1, the lower mold 2 incorporates the pushing out plate 28 (lower pushing out plate) connecting the pair of pushing out pins 26 (lower pushing out pins) and the pair of return pins 27. There is such a positional relationship in the lower mold 2 that the pushing out member 31 moves up by extending operation of the second hydraulic actuator 30 to push up the pushing out plate 28 and the pair of pushing out pins 26 and the return pins 27 move up. The distal end of each pushing out pin 26 pushes out a casting in a cavity (lower cavity). Note that the return pins 27 of the upper mold 1 and the lower mold 2 are pushed back at the time of mold closing, by a mating surface of the mold opposite to the distal ends of the return pins 27 or the distal ends of the opposite return pins 27. Accordingly, the pushing out pin 26 connected to the pushing out plate 28 is also pushed back. At the time of mold closing, contraction operation of the second hydraulic actuator 30 causes the pushing out member 31 to reach a descending end position. Note that the descending end refers to a lowest possible position of the lower mold 2 as the second hydraulic actuator 30 is contracted.

A pair of positioning keys 35 is mounted in the lower periphery (side face bottom end part) of the upper mold 1. A pair of key grooves 36 is provided in the upper periphery (side face top end part) of the lower mold 2 in such a way as to be engageable with the pair of positioning keys 35. The positioning keys 35 and the key grooves 36 constitute a positioning unit for positioning the upper mold 1 and the lower mold 2 in the horizontal direction. According to this positioning unit, since the upper mold 1 and the lower mold 2 are positioned in the horizontal direction, it is possible to prevent the upper mold 1 and the lower mold 2 from being displaced and closed.

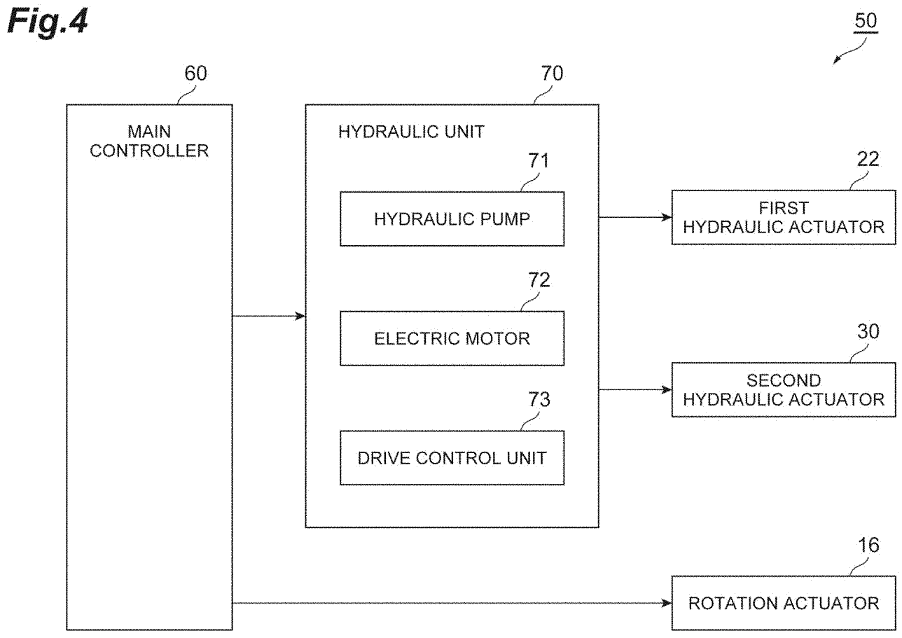

Next, the configuration relating to driving of the casting apparatus 50 will be described in detail. FIG. 4 is a block diagram of the configuration relating to driving of the casting apparatus 50 in FIG. 1. As shown in FIG. 4, the casting apparatus 50 is provided with a main controller 60 and a hydraulic unit 70.

The main controller 60 is hardware controlling the entire driving of the casting apparatus 50. The main controller 60 is constructed of a general-purpose computer including a computation apparatus such as a CPU (Central Processing Unit), a storage apparatus such as a ROM (Read Only Memory), a RAM (Random Access Memory), an HDD (Hard Disk Drive) and a communication apparatus or the like.

The main controller 60 is connected communicably with the hydraulic unit 70 and the rotation actuator 16. The hydraulic unit 70 supplies hydraulic oil to the first hydraulic actuator 22 and the second hydraulic actuator 30. The main controller 60 outputs a control signal to the hydraulic unit 70 and the rotation actuator 16 and controls driving of the first hydraulic actuator 22, the second hydraulic actuator 30 and the rotation actuator 16. The main controller 60 is connected to an operation panel (not shown) such as a touch panel and causes each actuator to operate according to command operation by an operator received by the operation panel. The main controller 60 can also cause each actuator to operate with reference to a casting recipe stored in the storage apparatus.

The hydraulic unit 70 is provided with a hydraulic circuit. The hydraulic circuit is a channel that circulates hydraulic oil of the hydraulic actuator. The hydraulic circuit includes a hydraulic pump 71, an electric motor 72, a solenoid valve (not shown), an oil tank (not shown) or the like. The hydraulic circuit supplies the hydraulic oil stored in the oil tank to the first hydraulic actuator 22 and the second hydraulic actuator 30. The hydraulic circuit collects the hydraulic oil from the first hydraulic actuator 22 and the second hydraulic actuator 30 and returns the hydraulic oil to the oil tank. In this way, the hydraulic circuit can circulate the hydraulic oil.

The hydraulic pump 71 suctions the hydraulic oil in the oil tank and supplies the hydraulic oil to the first hydraulic actuator 22 and the second hydraulic actuator 30. The electric motor 72 is a device driving the hydraulic pump and is, for example, a variable speed motor. The hydraulic oil is carried from the hydraulic pump according to the number of revolutions of the electric motor 72. A discharge flow rate of the hydraulic pump is calculated by multiplying the number of revolutions of the electric motor 72 by the volume of the hydraulic pump.

The hydraulic unit 70 is provided with a drive control unit 73 controlling the number of revolutions of the electric motor 72. The drive control unit 73 is a device controlling the number of revolutions of the electric motor 72. The drive control unit 73 includes a converter circuit that converts AC to DC and an inverter circuit that performs inverter control. The inverter circuit controls ON/OFF operation of a switching element provided for the inverter circuit. As an example, the drive control unit 73 receives the number of revolutions (rotation speed) of the electric motor 72 detected by a number of revolutions sensor (not shown) and a target number of revolutions (target rotation speed) as input, performs proportional integration (PI) control, and thereby generates a current command value. The drive control unit 73 generates a control signal to perform ON/OFF operation of the switching element based on the current command value and outputs the control signal to the inverter circuit. The electric motor 72 is thereby controlled in such a way as to operate at a predetermined number of revolutions at predetermined timing.

When performing mold opening or mold closing, the drive control unit 73 causes the electric motor 72 to operate at a predetermined number of revolutions and causes the electric motor 72 to operate at a limit number of revolutions smaller than the predetermined number of revolutions when not performing mold opening or mold closing. The limit number of revolutions is a predetermined number of revolutions with power consumption taken into account. In this way, by controlling the number of revolutions of the electric motor 72 using an inverter according to the casting step, it is possible to suppress power consumption compared to the case where the electric motor is always operated at a number of revolutions necessary for mold opening or mold closing.

The main controller 60 outputs a control signal to the rotation actuator 16 and performs position control of the rotation actuator 16. The “position control” refers to controlling the angle of rotation and the rotation speed of the rotation actuator 16 by a control signal. When the rotation actuator 16 is a servo motor, power is not supplied when the rotation actuator 16 is not driving.

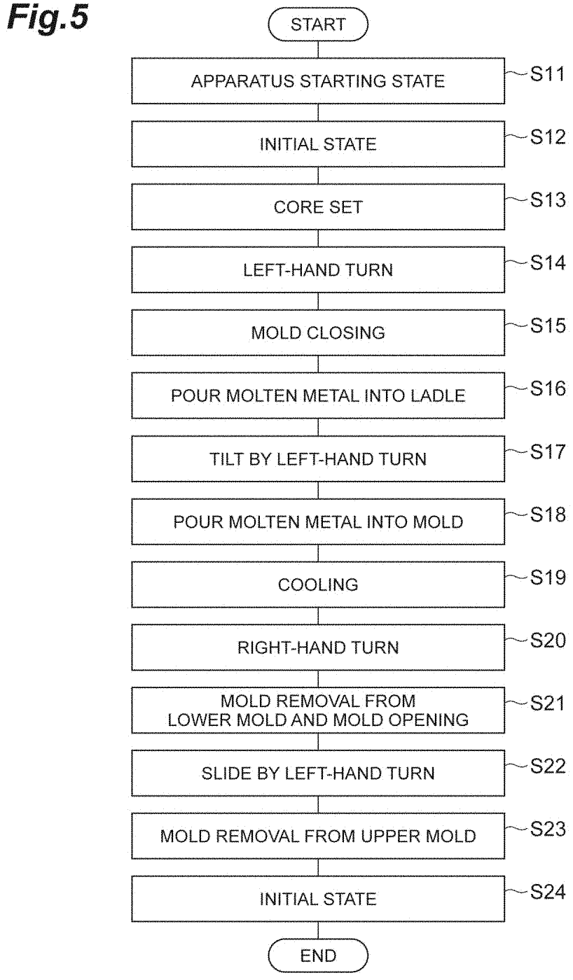

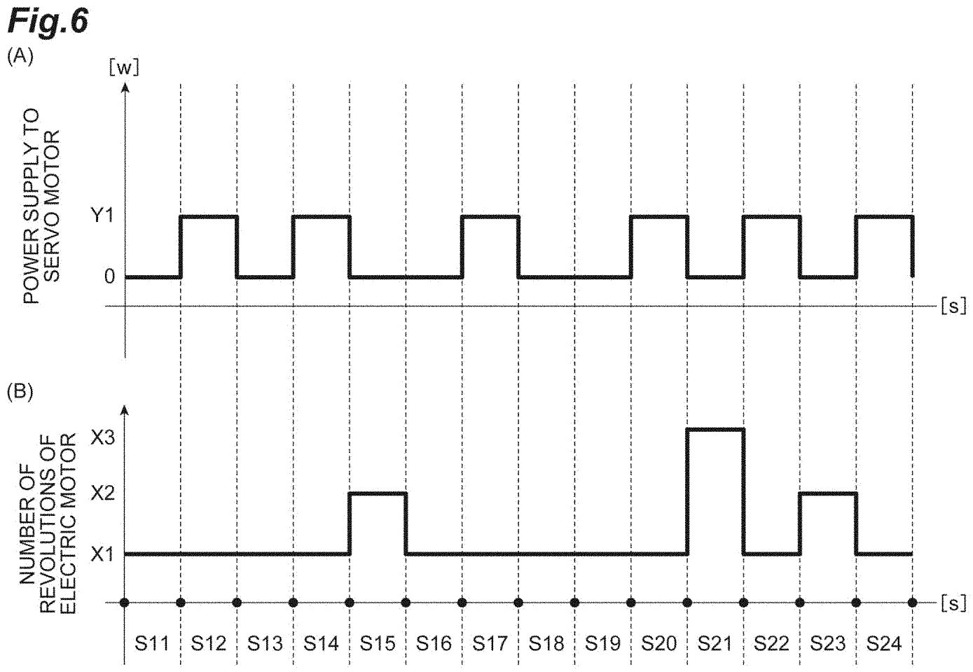

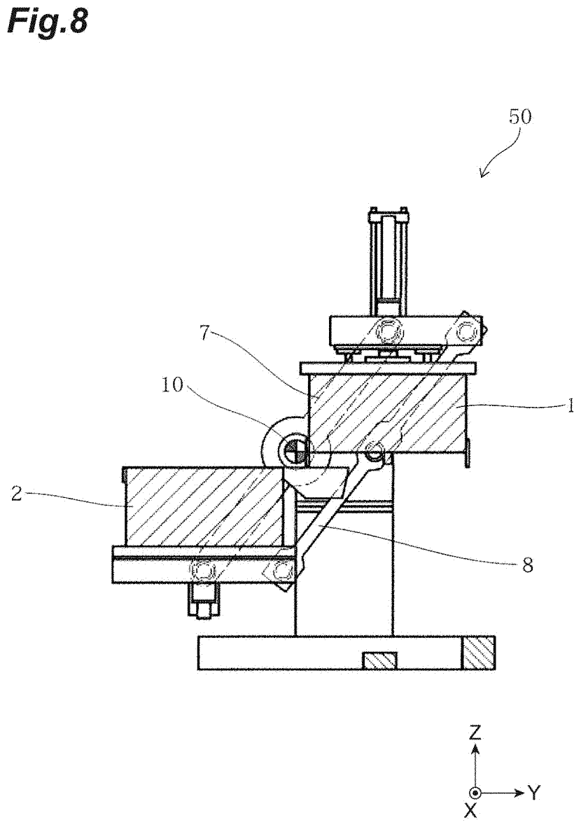

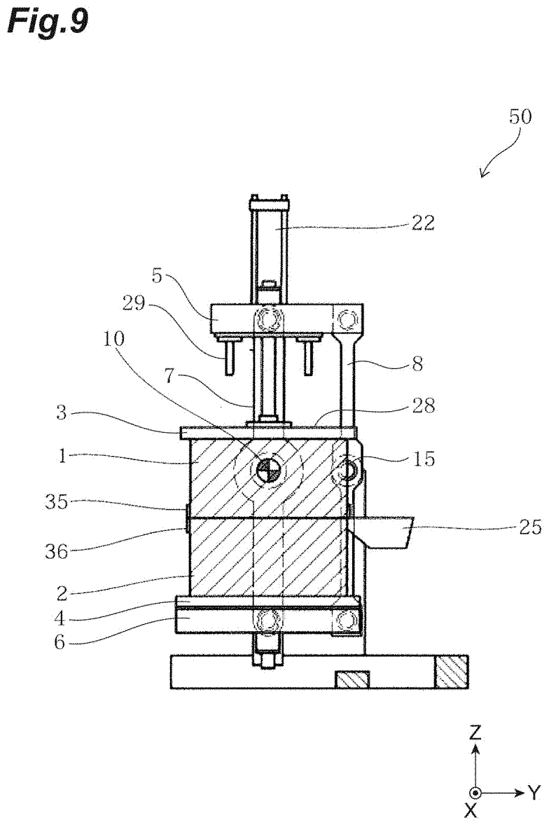

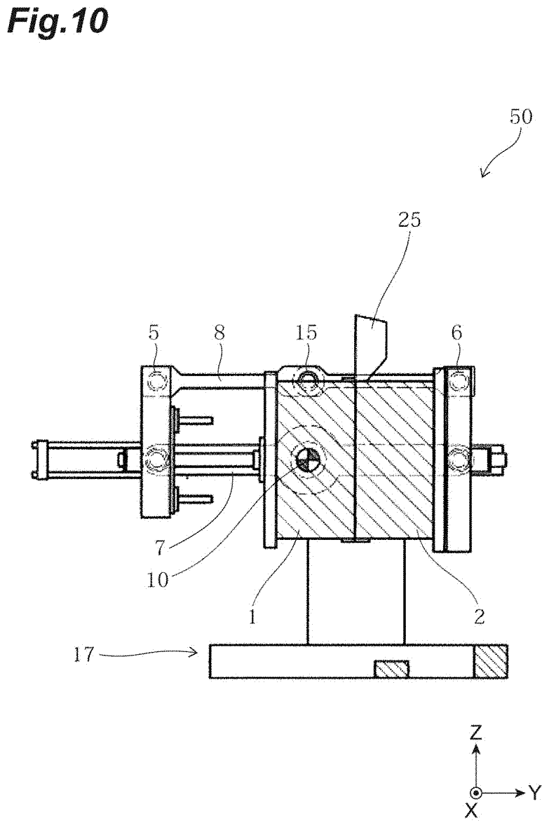

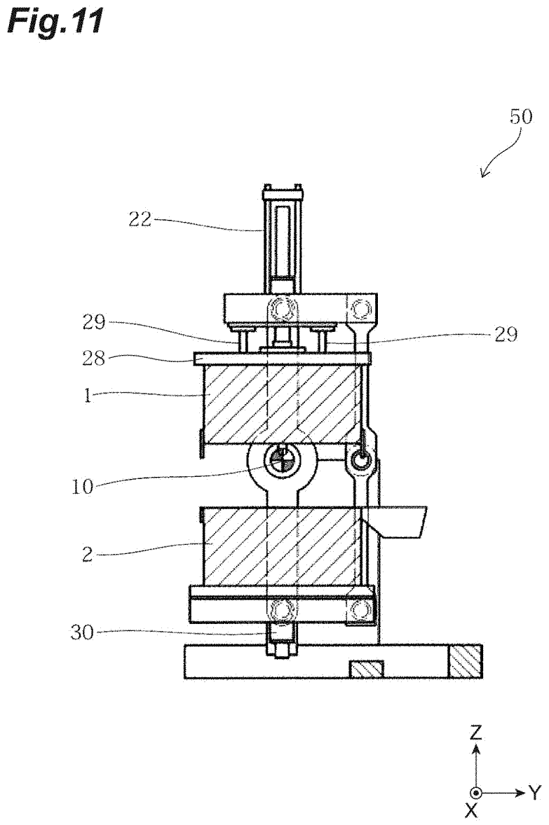

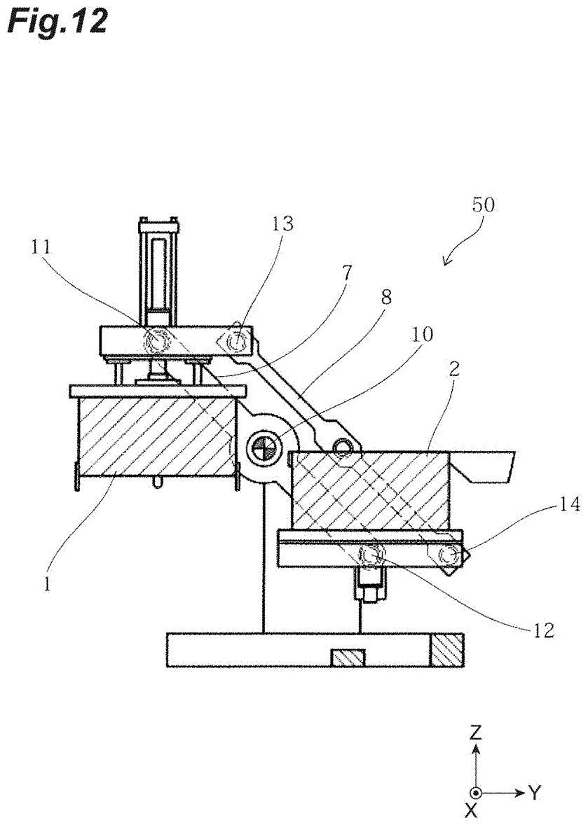

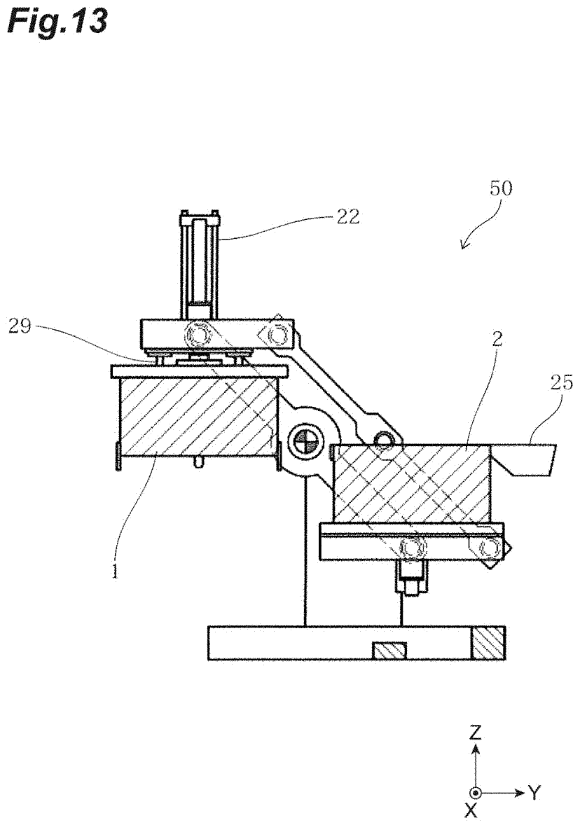

Next, an example of the casting method by the casting apparatus 50 will be described with reference to FIG. 5 to FIG. 13. FIG. 5 is a flowchart illustrating the casting method by the casting apparatus in FIG. 1. FIG. 6 is a graph illustrating power supplied to the servo motor in each step and the number of revolutions of the electric motor of the hydraulic pump. FIG. 7 is a diagram viewed from an arrow direction of a line A-A in FIG. 1 and for describing an apparatus starting state. FIG. 8 is a diagram illustrating a second separate state in which the upper and lower molds are slid through operation of a parallel link mechanism and describing an initial state of a manufacturing step. FIG. 9 is a diagram for describing a mold closed state in which the upper mold and the lower mold are closed. FIG. 10 is a diagram in which the closed upper mold and lower mold are tilted by 90°. FIG. 11 is a diagram illustrating the upper mold raised up to a midway position. FIG. 12 is a diagram illustrating the upper mold and the lower mold slid into a first separate state. FIG. 13 is a diagram illustrating the upper mold raised up to an ascending end from the state in FIG. 12.

As shown in FIG. 5 and FIG. 7, at the start of power supply, the upper mold 1 of the casting apparatus 50 is at an ascending end and the pair of main link members 7 and the pair of sub-link members 8 are perpendicular to the installation surface of the casting apparatus 50 (apparatus starting state: step S11). In step S11, the main power supply of the casting apparatus 50 is turned ON and the power supply to the hydraulic unit 70 is also turned ON together. The electric motor 72 starts operating at the limit number of revolutions (first number of revolutions X1) under the control of the main controller 60 (FIG. 6). The upper graph in FIG. 6 illustrates a change in every step of the power supply to the servo motor and the lower graph illustrates a change in every step of the number of revolutions of the electric motor 72.

Note that the casting apparatus 50 is disposed between a workspace (not shown) and a pouring apparatus (not shown). The casting apparatus 50 is disposed such that the ladle 25 faces the workspace (not shown) in the Y direction. The workspace is a space for the operator to perform a core fitting operation or the like. The pouring apparatus is an apparatus that pours molten metal into the ladle 25. For example, a conveyor (not shown) is disposed between the casting apparatus 50 and the workspace. The conveyor is an apparatus that carries a casting (cast product) cast by the casting apparatus 50. The conveyor extends up to an apparatus in a post-process (e.g., product cooling apparatus, sand shakeout apparatus, product finishing apparatus or the like).

Next, as shown in FIG. 5 and FIG. 8, the casting apparatus 50 is placed into an initial state of a series of casting processes (step S12). The casting apparatus 50 is changed from the state shown in FIG. 7 to an initial state shown in FIG. 8. The main controller 60 of the casting apparatus 50 outputs a control signal to drive the rotation actuator 16. In this way, the rotation actuator 16 is supplied with power (first power Y1) and driven according to a command (FIG. 6).

When the rotation actuator 16 is driven, the tilt rotating shaft 10 of the first main link member 7a turns clockwise. In the present embodiment, a turn in the clockwise direction is assumed to be a right-hand turn and the opposite turn is assumed to be a left-hand turn. Accordingly, the upper mold 1 and the lower mold 2 slide in an arc in opposite directions through action of the parallel link mechanism. More specifically, when the mutually opposing upper mold 1 and lower mold 2 make circular motion of right-hand turn around the tilt rotating shaft 10 as a central axis, and the upper mold 1 and the lower mold 2 move away from each other in the horizontal direction. At this time, the upper mold 1 has moved to the pouring apparatus side (second separate state). This second separate state is an initial state of a series of casting steps. In the present embodiment, the state in which the lower mold 2 has moved to the pouring apparatus side is assumed to be a first separate state and the state in which the upper mold 1 has moved to the pouring apparatus side is assumed to be a second separate state. That is, the first separate state (see FIG. 12) is a state in which the rotation actuator 16 causes the upper mold 1 to move in a direction away from the pouring apparatus and the lower mold 2 moves in a direction approaching the pouring apparatus, whereby the upper mold 1 and the lower mold 2 remain separate from each other in the horizontal direction. The second separate state (see FIG. 8) is a state in which the rotation actuator 16 causes the upper mold 1 to move in the direction approaching the pouring apparatus and the lower mold 2 moves in a direction away from the pouring apparatus, whereby the upper mold 1 and the lower mold 2 remain separate from each other in the horizontal direction.

Next, the core 34 is fitted in a predetermined position of the lower mold 2 (step S13). Fitting of the core 34 is performed by, for example, the operator. The core 34 is molded using, for example, a core molding machine (not shown). In the second separate state, the lower mold 2 is open upward in which the ladle 25 mounted on the lower mold 2 is not in contact with the upper mold 1. Since the lower mold 2 is open upward in this way, the core 34 can be fitted in the lower mold 2 safely.

Next, the casting apparatus 50 causes the rotation actuator 16 to drive the tilt rotating shaft 10 of the first main link member 7a to turn counterclockwise and then return to the apparatus starting state in FIG. 7 (step S14). The main controller 60 of the casting apparatus 50 outputs a control signal to drive the rotation actuator 16. In this way, the rotation actuator 16 is supplied with power (first power Y1) and driven according to a command (FIG. 6).

Next, as shown in FIG. 5 and FIG. 9, the casting apparatus 50 extends the first hydraulic actuator 22 to close the upper mold 1 and the lower mold 2 (step S15). The drive control unit 73 of the hydraulic unit 70 causes the electric motor 72 to operate at a predetermined number of revolutions (second number of revolutions X2) larger than the first number of revolutions X1 (FIG. 6). The first hydraulic actuator 22 extends when supplied with the hydraulic oil. At this time, the positioning key 35 of the upper mold 1 engages with the key groove 36 of the lower mold 2, and the upper mold 1 and the lower mold 2 are fixed in the horizontal direction. Furthermore, mold closing prevents rotations of the pair of main link members 7 and the pair of sub-link members 8, the main link upper rotating shaft 11, the main link lower rotating shaft 12, the sub-link upper rotating shaft 13 and the sub-link lower rotating shaft 14, which integrates the upper mold 1, the lower mold 2, the upper frame 5, the lower frame 6, the pair of main link members 7 and the pair of sub-link members 8 together.

Next, when the upper mold 1 and the lower mold 2 are closed, that is, in a mold-closed state, the pouring apparatus supplies molten metal into the ladle 25 (step S16). Next, as shown in FIG. 5 and FIG. 10, the casting apparatus 50 causes the rotation actuator 16 to drive the tilt rotating shaft 10 of the first main link member 7a to turn counterclockwise by approximately 90° to bring the upper mold I and the lower mold 2 into a tilted state (step S17). The main controller 60 of the casting apparatus 50 outputs a control signal to drive the rotation actuator 16. In this way, the rotation actuator 16 is supplied with power (first power Y1) and driven according to a command (FIG. 6). The sub-link central part rotating shaft 15 is thereby raised from the top surface of the base frame 17 on which it had been placed. Accordingly, the closed and integrated upper mold 1, lower mold 2, upper frame 5, lower frame 6, pair of main link members 7 and pair of sub-link members 8 rotate and the molten metal in the ladle 25 is tilted and poured into the cavity formed between the upper mold 1 and the lower mold 2 (step S18).

After the process in above step S18 ends, the state in FIG. 10 is kept for a predetermined time, waiting for the poured molten metal to coagulate (cool) (step S19). Note that as described above, the rotation actuator 16 is caused to drive the tilt rotating shaft 10 of the first main link member 7a to turn counterclockwise by approximately 90°, but the tilt rotating shaft 10 may also be caused to turn by a predetermined angle within a range of 45° to 130° or 45° to 90°.

Next, the main controller 60 of the casting apparatus 50 causes the rotation actuator 16 to drive the tilt rotating shaft 10 of the first main link member 7a to turn clockwise and return to the state in FIG. 9 (step S20). The main controller 60 of the casting apparatus 50 outputs a control signal to drive the rotation actuator 16. In this way, the rotation actuator 16 is supplied with power (first power Y1) and driven according to a command (FIG. 6).

Next, mold removal and mold opening from the lower mold 2 are simultaneously performed (step S21). Mold opening is performed as shown in FIG. 5 and FIG. 11 and mold removal from the lower mold 2 is also performed simultaneously. Mold opening is started by the casting apparatus 50 operating the first hydraulic actuator 22. The drive control unit 73 of the hydraulic unit 70 causes the electric motor 72 to operate at a predetermined number of revolutions (third number of revolutions X3) larger than the first number of revolutions X1 and the second number of revolutions X2 (FIG. 6). This causes the first hydraulic actuator 22 to contract and causes the upper mold 1 to move up. Mold opening of the upper mold 1 and the lower mold 2 starts in this way. Extending operation of the second hydraulic actuator 30 starts simultaneously with the contracting operation of the first hydraulic actuator 22. That is, the hydraulic unit 70 also supplies hydraulic oil to the second hydraulic actuator 30. When the second hydraulic actuator 30 extends, the pushing out pin 26 (see FIG. 3) incorporated in the lower mold 2 is pushed out. This causes the casting (not shown) consisting of coagulated molten metal in the upper mold 1 and the lower mold 2 to be removed from the lower mold 2 and remain held to the upper mold 1. The casting apparatus 50 causes the upper mold I to move up to a predetermined position and mold opening is completed. The predetermined position is a position where the distal end of the push rod 29 is not in contact with the top surface of the pushing out plate 28 of the upper mold I. In other words, the predetermined position is a position where there is a gap between the distal end of the push rod 29 and the top surface of the pushing out plate 28 of the upper mold 1.

Next, as shown in FIG. 5 and FIG. 12, the casting apparatus 50 causes the rotation actuator 16 to drive the tilt rotating shaft 10 of the first main link member 7a to turn counterclockwise (step S22). The main controller 60 of the casting apparatus 50 outputs a control signal to drive the rotation actuator 16. In this way, the rotation actuator 16 is supplied with power (first power Y1) and driven according to a command (FIG. 6). Through the action of the parallel link mechanism, the casting apparatus 50 causes the upper mold 1 and the lower mold 2 to slide in an arc and separates them apart in the horizontal direction. At this time, a state in which the upper mold 1 has moved to the conveyor side, that is, a first separate state in which the lower mold 2 has moved in a direction approaching the pouring apparatus. The angle of left-hand turn of the rotation actuator 16 at this time becomes on the order of 30° to 45° at which the upper mold 1 is opened downward.

Next, as shown in FIG. 5 and FIG. 13, the casting apparatus 50 contracts the first hydraulic actuator 22 to move the upper mold 1 up to an ascending end. The drive control unit 73 of the hydraulic unit 70 causes the electric motor 72 to operate at a predetermined number of revolutions (second number of revolutions X2) larger than the first number of revolutions X1 (FIG. 6). When the hydraulic oil is supplied, the first hydraulic actuator 22 extends. In this way, the distal end of the push rod 29 relatively pushes out the pushing out pin 26 (see FIG. 7) with respect to the upper mold 1 via the pushing out plate 28 incorporated in the upper mold 1. As a result, the casting held to the upper mold 1 is removed from the upper mold 1 (step S23). The casting removed from the upper mold 1 drops and is received by the conveyor provided below the upper mold 1. That is, the conveyor functions as a receiver receiving the casting as well. After that, the casting is carried by the conveyor to, for example, a product cooling apparatus, a sand shakeout apparatus and a product finishing apparatus carrying out deburring or the like.

Next, as shown in FIG. 5, the casting apparatus 50 causes the rotation actuator 16 to drive the tilt rotating shaft 10 of the first main link member 7a to turn clockwise (step S22). The main controller 60 of the casting apparatus 50 outputs a control signal to drive the rotation actuator 16. In this way, the rotation actuator 16 is supplied with power (first power Y1) and driven according to a command (FIG. 6). In this way, the casting apparatus 50 returns to the initial state (FIG. 8). As described above, a series of casting processes are completed and a casting is cast by the casting apparatus 50. When the casting processes are consecutively performed, castings can be cast consecutively by repeating processes from the core setting process in step S13.

As described above, the casting apparatus 50 connects the upper frame 5 to which the upper mold 1 is attached, the lower frame 6 to which the lower mold 2 is attached, the pair of left and right main link members 7 and the pair of left and right sub-link members 8 to constitute a parallel link mechanism. The tilt rotating shaft 10 is provided at the central part of the main link member 7 and the sub-link central part rotating shaft 15 is provided at the central part of the sub-link member 8. Furthermore, the casting apparatus 50 holds the tilt rotating shaft 10 to the base frame 17 using the tilting rotation bearing 9 provided outside the pair of left and right parallel link mechanisms, places the sub-link central part rotating shaft 15 on the base frame 17 and attaches the rotation actuator 16 to the tilt rotating shaft 10 on the drive side support frame 19 side.

The first hydraulic actuator 22 realizes mold closing and mold opening. The electric motor 72 of the hydraulic pump supplying hydraulic oil to the first hydraulic actuator 22 under the drive control unit 73 operates at a predetermined number of revolutions (second number of revolutions X2, third number of revolutions X3) when performing mold opening or mold closing, and operates at a limit number of revolutions (first number of revolutions X1) smaller than the predetermined number of revolutions when not performing mold opening or mold closing. Thus, the casting apparatus 50 can suppress power consumption compared to the case where the electric motor is always operated at a number of revolutions necessary when performing mold opening or mold closing.

By adopting the first hydraulic actuator 22 for the opening/closing mechanism 21 for mold closing and mold opening, it is possible to simplify and miniaturize the apparatus structure compared to the case where an electric actuator is adopted. The hydraulic unit 70 can be disposed away from the apparatus body (whole of the apparatus in FIG. 1). Thus, when a plurality of apparatus bodies are disposed, it is possible to reduce distances among the apparatus bodies. In this way, it is possible to improve the degree of freedom of the apparatus layout by adopting the hydraulic actuator.

In the casting apparatus 50, one hydraulic unit 70 causes a plurality of hydraulic actuators to operate, and it is thereby possible to suppress power consumption compared to the case where the hydraulic actuators are connected to their respective hydraulic units each including an electric motor.

When removing a casting from the upper mold 1, since the casting apparatus 50 causes the first hydraulic actuator 22 to operate, the electric motor 72 operates at a number of revolutions larger than the first number of revolutions (limit number of revolutions). That is, since the casting apparatus 50 can cause the electric motor to operate at the limit number of revolutions except for mold closing, mold opening or mold removal, it is possible to suppress power consumption compared to the case where the electric motor is always operated at a number of revolutions necessary for mold opening or mold closing.

The drive control unit 73 reduces the number of revolutions of the electric motor 72 when performing mold closing compared to when performing mold opening. When performing mold opening, a casting needs to be removed from the mold, and so a larger number of revolutions is required than when performing mold closing. The casting apparatus 50 can thus suppress power consumption compared to the case where the electric motor is always operated at a number of revolutions necessary for mold opening.

By adopting a servo motor as the rotation actuator 16, the casting apparatus 50 can cause the link mechanism to operate accurately. When not in operation, the servo motor consumes no power. Compared to the case where a hydraulic actuator is adopted as the rotation actuator 16, the casting apparatus 50 can suppress power consumption. Moreover, by simultaneously using the hydraulic actuator and the servo motor, it is possible to implement an apparatus with excellent balance among the degree of freedom in the apparatus layout, running cost and initial cost (introduction cost).

### Second Embodiment

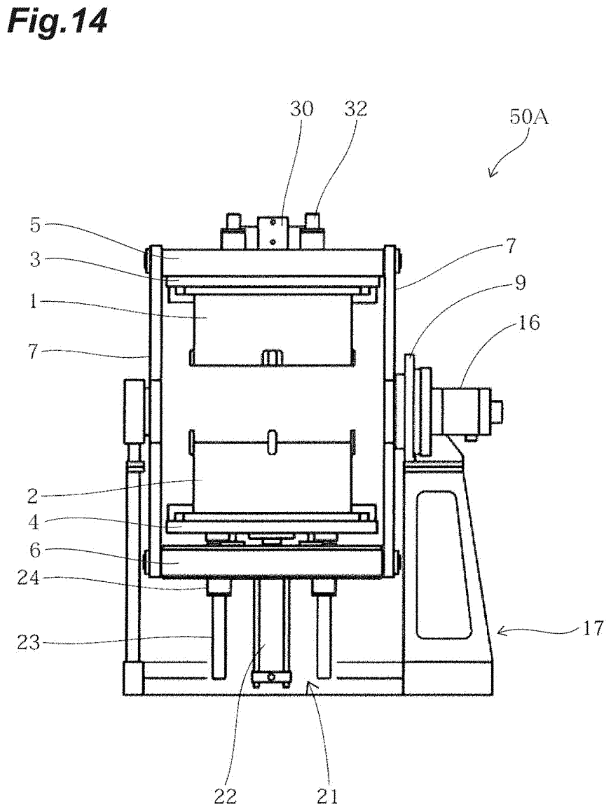

FIG. 14 is a front view of a casting apparatus according to a second embodiment. As shown in FIG. 14, a casting apparatus 50A according to the second embodiment is different from the casting apparatus 50 according to the first embodiment mainly in that the opening/closing mechanism 21 moving the lower mold 2 up and down is provided in the lower frame 6. Thus, the lower mold 2 of the casting apparatus 50A can move up and down. Hereinafter, differences between the casting apparatus 50A according to the second embodiment and the casting apparatus 50 according to the first embodiment will be described mainly and common description thereof will be omitted.

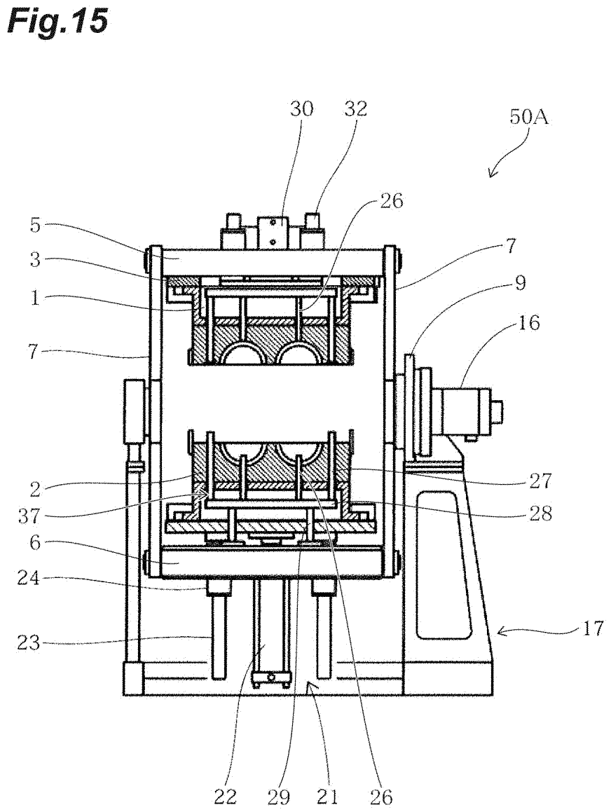

FIG. 15 is a diagram illustrating cross sections of the upper die and the lower die in FIG. 14. As shown in FIG. 15, in the casting apparatus 50A, the second hydraulic actuator 30 is provided in the upper frame 5 and the pushing out mechanism 37 is provided in the lower frame 6. In the casting apparatus 50A, the pushing out plate 28 is disposed in an inner space formed in the interior on the bottom end side of the lower mold 2. Each pushing out pin 26 is provided on the top surface of the pushing out plate 28. Each pushing out pin 26 moves up and down through a hole from the inner space of the lower mold 2 to a cavity in which a casting is formed. A distal end of each pushing out pin 26 pushes out the casting in the cavity. Each return pin 27 is provided at a position different from the pushing out pin 26 at the top surface of the pushing out plate 28. Each return pin 27 moves up and down through the hole from the inner space of the lower mold 2 to the top surface of the lower mold 2. In a process in which the upper mold 1 and the lower mold 2 are closed, the distal end of each return pin 27 is abutted against the undersurface of the upper mold 1 to thereby cause the pushing out plate 28 to move down.

Each push rod 29 is provided on the top surface of the lower frame 6. Each push rod 29 is disposed on the top surface of the lower frame 6 by penetrating the lower mold die base 4. Each push rod 29 is inserted into a hole penetrating from the undersurface of the lower mold 2 to the inner space and the distal end of each push rod 29 is disposed below the pushing out plate 28 in the inner space. The length of each push rod 29 is set to a length that the pushing out plate 28 is pushed up when the first hydraulic actuator 22 is contracted and the lower mold 2 becomes a descending end. That is, each push rod 29 passes through the hole penetrating an inner space formed at a lower position of the lower mold 2 from the undersurface of the lower mold 2 and enters the inner space by a predetermined length to prevent the pushing out plate 28 from moving down. The rest of the configuration is the same as that of the casting apparatus 50 according to the first embodiment.

According to the casting method for the casting apparatus 50A, in above step 821, mold removal from the upper mold 1 and mold opening are performed in parallel. More specifically, the casting apparatus 50A causes the lower mold 2 to move down through the opening/closing mechanism 21 provided in the lower frame 6 and starts mold opening of the upper mold 1 and the lower mold 2. Simultaneously with this, the casting apparatus 50A starts extending operation of the second hydraulic actuator 30 provided in the upper frame 5. Extension of the second hydraulic actuator 30 causes the pushing out pin 26 incorporated in the upper mold 1 to be pushed out. In this way, a casting (not shown) made of molten metal coagulating in the upper mold 1 and the lower mold 2 is removed from the upper mold 1 and held to the lower mold 2. In above process S23, mold removal from the lower mold 2 is performed. More specifically, the opening/closing mechanism 21 causes the lower mold 2 to move down to a descending end. Thus, the distal end of the push rod 29 relatively pushes out the pushing out pin 26 with respect to the lower mold 2 via the pushing out plate 28 incorporated in the lower mold 2. As a result, the casting held to the lower mold 2 is removed from the lower mold 2.

The casting apparatus 50A exerts the same effects as those of the aforementioned casting apparatus 50.

The respective embodiments have been described so far, but the present disclosure is not limited to the above respective embodiments. For example, instead of the second hydraulic actuator 30 removing a casting from the upper mold 1 or the lower mold 2, the pushing out plate 28 may be pushed out using a spring. In that case, at the time of mold closing of the upper mold 1 and the lower mold 2, the return pin 27 of the lower mold 2 is pressed down by the upper mold 1 and the pushing out pin 26 is lowered, in which a mold closing force is offset by the pressing force of the return pin 27, but it is possible to reduce the number of actuators.

It is possible to provide more than one casting apparatus 50. At this time, there is no limit to an arrangement of the casting apparatus as long as the pouring apparatus can pour molten metal. The core may be fitted not only by the operator but also by a core fitting robot provided with articulated arms. The opening/closing mechanism 21 may cause both the upper mold 1 and the lower mold 2 to move up and down.

### Reference Signs List

1 . . . upper mold, 2 . . . lower mold, 5 . . . upper frame, 6 . . . lower frame, 7 . . . a pair of main link members, 7a . . . first main link member, 7b . . . second main link member, 8 . . . a pair of sub-link members, 8a . . . first sub-link member, 8b . . . second sub-link member, 10 . . . tilt rotating shaft, 15 . . . sub-link central part rotating shaft, 16 . . . rotation actuator (drive unit), 17 . . . base frame, 21 . . . opening/closing mechanism, 22 . . . first hydraulic actuator, 25 . . . ladle, 25a . . . pouring hole, 26 . . . pushing out pin, 27 . . . return pin, 28 . . . pushing out plate, 29 . . . push rod (regulating member), 30 . . . second hydraulic actuator, 35 . . . positioning key, 36 . . . key groove, 50, 50A . . . casting apparatus, 60 . . . main controller, 70 . . . hydraulic unit, 71 . . . hydraulic pump, 72 . . . electric motor, 73 . . . drive control unit

1. A casting apparatus that forms a casting by using an upper mold and a lower mold, which can be opened, closed, and tilted, into which molten metal is poured by using gravity, the casting apparatus comprising:
a first hydraulic actuator configured to move either the upper mold or the lower mold up and down to thereby open or close the upper mold and the lower mold; and
a hydraulic unit configured to drive the first hydraulic actuator, wherein
the hydraulic unit comprises:
a hydraulic pump configured to supply hydraulic oil to the first hydraulic actuator;
an electric motor configured to drive the hydraulic pump; and
a drive control unit configured to control a number of revolutions of the electric motor, and
when performing mold opening or mold closing, the drive control unit operates the electric motor at a predetermined number of revolutions, and when not performing mold opening or mold closing, the drive control unit operates the electric motor at a limit number of revolutions smaller than the predetermined number of revolutions.

2. The casting apparatus according to claim 1, wherein the first hydraulic actuator moves the upper mold up and down to perform mold closing and mold opening,
the casting apparatus further comprises:
a lower pushing out pin inserted into a hole communicating with a lower cavity of the lower mold in which the casting is formed, a leading end of which pushes out the casting in the lower cavity; and
a second hydraulic actuator connected to the hydraulic unit to move the lower pushing out pin up and down, and
the hydraulic pump is further configured to supply hydraulic oil to the second hydraulic actuator when performing mold opening.

3. The casting apparatus according to claim 1, further comprising:
an upper pushing out plate enabled by the first hydraulic actuator to freely move up and down; and
an upper pushing out pin inserted into a hole communicating with an upper cavity of the upper mold in which the casting is formed, caused by the first hydraulic actuator to move up and down, and a leading end of which pushes out the casting in the upper cavity, wherein
when removing the casting in the upper cavity from the mold, the drive control unit causes the electric motor to operate at a number of revolutions larger than the limit number of revolutions.

4. The casting apparatus according to claim 1, wherein
the first hydraulic actuator moves the lower mold up and down to perform mold closing and mold opening,
the casting apparatus further comprises:
an upper pushing out pin inserted into a hole communicating with an upper cavity of the upper mold in which a casting is formed, a leading end of which pushes out the casting in the upper cavity; and
a second hydraulic actuator connected to the hydraulic unit and configured to move the upper pushing out pin up and down, and
the hydraulic pump is further configured to supply hydraulic oil to the second hydraulic actuator when performing mold opening.

5. The casting apparatus according to claim 1, further comprising:
a lower pushing out plate enabled by the first hydraulic actuator to freely move up and down; and
an upper pushing out pin inserted into a hole communicating with a lower cavity of the lower mold in which the casting is formed, caused by the first hydraulic actuator to move up and down, and a leading end of which pushes out the casting in the lower cavity, wherein
when removing the casting in the lower cavity from the mold, the drive control unit causes the electric motor to operate at a number of revolutions larger than the limit number of revolutions.

6. The casting apparatus according to claim 1, wherein the drive control unit reduces the number of revolutions of the electric motor when performing mold closing compared to when performing mold opening.

7. The casting apparatus according to claim 1, further comprising:
an upper frame to which the upper mold is attached;
a lower frame to which a lower mold is attached;
a first main link member, a top end part of which is rotatably connected to the upper frame, a bottom end part of which is rotatably connected to the lower frame and a central part of which is provided with a rotating shaft;
a first sub-link member disposed parallel to the first main link member, a top end part of which is rotatably connected to the upper frame, a bottom end part of which is rotatably connected to the lower frame and a central part of which is provided with a rotating shaft; and
a drive unit connected to the rotating shaft of the first main link member and configured to rotate the first main link member around the rotating shaft as a center, wherein
the upper frame, the lower frame, the first main link member and the first sub-link member constitute a first parallel link mechanism.

8. The casting apparatus according to claim 7, wherein the drive unit is a servo motor.

9. The casting apparatus according to claim 8, wherein when the upper mold and the lower mold are tilted or when the upper mold is separated from the lower mold in a horizontal direction, the servo motor is supplied with power.

10. A casting method using a casting apparatus that forms a casting by using an upper mold and a lower mold, which can be opened, closed, and tilted, into which molten metal is poured by using gravity, the casting apparatus comprising:
a first hydraulic actuator configured to move either the upper mold or the lower mold up and down to thereby open or close the upper mold and the lower mold; and
a hydraulic unit configured to drive the first hydraulic actuator, wherein
the hydraulic unit comprises:
a hydraulic pump configured to supply hydraulic oil to the first hydraulic actuator; and
an electric motor configured to drive the hydraulic pump, and
the method comprises a mold closing step and a mold opening step,
in the mold closing step and the mold opening step, the electric motor operates at a predetermined number of revolutions, and
when not in the mold closing step or in the mold opening step, the electric motor operates at a limit number of revolutions smaller than the predetermined number of revolutions.

11. The casting apparatus according to claim 2, further comprising:
an upper pushing out plate enabled by the first hydraulic actuator to freely move up and down; and
an upper pushing out pin inserted into a hole communicating with an upper cavity of the upper mold in which the casting is formed, caused by the first hydraulic actuator to move up and down, and a leading end of which pushes out the casting in the upper cavity, wherein
when removing the casting in the upper cavity from the mold, the drive control unit causes the electric motor to operate at a number of revolutions larger than the limit number of revolutions.

12. The casting apparatus according to claim 4, further comprising:
a lower pushing out plate enabled by the first hydraulic actuator to freely move up and down; and
an upper pushing out pin inserted into a hole communicating with a lower cavity of the lower mold in which the casting is formed, caused by the first hydraulic actuator to move up and down, and a leading end of which pushes out the casting in the lower cavity, wherein
when removing the casting in the lower cavity from the mold, the drive control unit causes the electric motor to operate at a number of revolutions larger than the limit number of revolutions.

13. The casting apparatus according to claim 2, wherein the drive control unit reduces the number of revolutions of the electric motor when performing mold closing compared to when performing mold opening.

14. The casting apparatus according to claim 3, wherein the drive control unit reduces the number of revolutions of the electric motor when performing mold closing compared to when performing mold opening.

15. The casting apparatus according to claim 4, wherein the drive control unit reduces the number of revolutions of the electric motor when performing mold closing compared to when performing mold opening.

16. The casting apparatus according to claim 5, wherein the drive control unit reduces the number of revolutions of the electric motor when performing mold closing compared to when performing mold opening.

17. The casting apparatus according to claim 2, further comprising:
an upper frame to which the upper mold is attached;
a lower frame to which a lower mold is attached;
a first main link member, a top end part of which is rotatably connected to the upper frame, a bottom end part of which is rotatably connected to the lower frame and a central part of which is provided with a rotating shaft;
a first sub-link member disposed parallel to the first main link member, a top end part of which is rotatably connected to the upper frame, a bottom end part of which is rotatably connected to the lower frame and a central part of which is provided with a rotating shaft; and
a drive unit connected to the rotating shaft of the first main link member and configured to rotate the first main link member around the rotating shaft as a center, wherein
the upper frame, the lower frame, the first main link member and the first sub-link member constitute a first parallel link mechanism.

18. The casting apparatus according to claim 3, further comprising:
an upper frame to which the upper mold is attached;
a lower frame to which a lower mold is attached;
a first main link member, a top end part of which is rotatably connected to the upper frame, a bottom end part of which is rotatably connected to the lower frame and a central part of which is provided with a rotating shaft;
a first sub-link member disposed parallel to the first main link member, a top end part of which is rotatably connected to the upper frame, a bottom end part of which is rotatably connected to the lower frame and a central part of which is provided with a rotating shaft; and
a drive unit connected to the rotating shaft of the first main link member and configured to rotate the first main link member around the rotating shaft as a center, wherein
the upper frame, the lower frame, the first main link member and the first sub-link member constitute a first parallel link mechanism.

19. The casting apparatus according to claim 4, further comprising:
an upper frame to which the upper mold is attached;
a lower frame to which a lower mold is attached;
a first main link member, a top end part of which is rotatably connected to the upper frame, a bottom end part of which is rotatably connected to the lower frame and a central part of which is provided with a rotating shaft;
a first sub-link member disposed parallel to the first main link member, a top end part of which is rotatably connected to the upper frame, a bottom end part of which is rotatably connected to the lower frame and a central part of which is provided with a rotating shaft; and
a drive unit connected to the rotating shaft of the first main link member and configured to rotate the first main link member around the rotating shaft as a center, wherein
the upper frame, the lower frame, the first main link member and the first sub-link member constitute a first parallel link mechanism.

20. The casting apparatus according to claim 5, further comprising:
an upper frame to which the upper mold is attached;
a lower frame to which a lower mold is attached;
a first main link member, a top end part of which is rotatably connected to the upper frame, a bottom end part of which is rotatably connected to the lower frame and a central part of which is provided with a rotating shaft;
a first sub-link member disposed parallel to the first main link member, a top end part of which is rotatably connected to the upper frame, a bottom end part of which is rotatably connected to the lower frame and a central part of which is provided with a rotating shaft; and
a drive unit connected to the rotating shaft of the first main link member and configured to rotate the first main link member around the rotating shaft as a center, wherein
the upper frame, the lower frame, the first main link member and the first sub-link member constitute a first parallel link mechanism.
